(19) United States
(12) Patent Application Publication
(10) Pub. No.: US 2014/0125561 A1
(43) Pub. Date: May 8, 2014

(54) System and Method for Displaying Characters

(71) Applicants: Man Wai Mak, Hong Kong (HK); Yun Long LIAO, Ganzhou (CN)

(72) Inventors: Man Wai Mak, Hong Kong (HK); Yun Long LIAO, Ganzhou (CN)

(21) Appl. No.: 13/734,998

(22) Filed: Jan. 6, 2013

(30) Foreign Application Priority Data
Nov. 8, 2012 (CN) 201210445162. 7

(51) Int. Cl. G09G 3/14

(52) U.S. Cl. CPC G09G 3/14
USPC 345/46; 345/82

(57) ABSTRACT

The present invention provides a system and method for displaying characters, including: rotary component (1), power supply (2,9), said power supply (2) is connected to said rotary component (1); a plurality of LED lamps (3) configured on said rotary component (1) in an array arrangement manner and connected to said power supply (2); display control unit (4) electrically connected with said power supply (2) and communicatively connected with said LED lamps (3); character storage unit (5); character editing unit (6); character emitting unit (7) and character receiving unit (8). The system of the present invention allows users to self-define the display content displayed by said LED lamps on the rotary component by character editing unit, increasing interactivity and playability of a rotary product.

### BACKGROUND OF THE PRESENT INVENTION

1. Field of Invention

The present invention relates to a charger, and more particularly to a charger comprising a multi-sided charging arrangement, wherein rechargeable batteries can be accommodated on a plurality of charging sides of the charger for being recharged.

2. Description of Related Arts

The present invention relates to mechatronics technology field. More specifically, the present invention relates to a system and method fir displaying characters in remote control flying Toys through remote controller with LCD screen.

In modern life, a variety of fashion goods, such as toys, electronic products are emerged in endlessly. These products show beautiful out-looking, compact and practical, usually used as a small gift for various occasions. Most of them are those products with a rotary type of electric motor, such as hand-held fans, remote-controlled aircraft, remote-controlled car. These products are used as a small gift with a high degree of publicity and advertising functions.

By configuring light-emitting LED lamp on a rotary component of a rotary type product to control the LED lamps on and off, people feel various colors of text or pattern formed within a rotation area due to human visual stagnation to achieve an advertising purpose when the lamps rotate at high speed. Human eye's is ability to retain image for a few hundred of a second. Chinese patent application “electric fans” (Patent number: 200320131528.X) and Chinese patent application “an electronic fan” (patent number: 200320131528.X) disclosed as product in which LED lamps are configured on rotary blades of an electric fan, presetting the rule of the LED lamps on and of so as to make people can see the specified text or pattern when the LED lamps rotate at a high speed. In addition to electric fans, the same effect can be produced in the products such as a remote-controlled aircraft and a remote-controlled car, etc.

However, as the display effect described in prior art, it is necessary to display different content in multiple products because the display content is fixed so that only a single content can be displayed and also cannot be modified.

### SUMMARY OF THE PRESENT INVENTION

In order to overcome the disadvantages above, one object of the present invention is to provide a system and method for displaying characters, users can self-define the contents of the letters and patterns formed by LED lamps configured on a rotary component.

The present invention, provides a system and method for displaying characters in remote control flying Toys through remote controller with LCD screen.

In order to achieve the object above, in one aspect of the present invention is to provide a character display system, including: a rotary component; power supply connected to said rotary component; a plurality of LED lamps configured on said rotary component in an array arrangement and connected to said power supply; display control unit electrically connected with said power supply and communicatively connected with said plurality of LED lamps; character storage unit presorting character set therein and providing storage space for storing character thereof, and electrically connected with said power supply and communicatively connected with character editing, unit; character editing unit electrically connected to the power supply and communicatively connected with said character storage unit in order to take out of characters from said character storage unit and to edit characters or character string, and output the signal of the ideographic characters or character string; character emitting unit electrically connected to power supply and communicatively connected with said character editing unit so as to emit signal of the ideographic characters or character string edited by said character editing unit; character receiving unit electrically connected to said power supply and communicatively connected with said character emitting, unit so as to receive the signal of the ideographic character or character string and transmits the signal of the ideographic characters or character string toward said display control unit; said display control unit provides a communication connection so as to transmit the signal of ideographic characters or character string of said character receiving unit to the LED lamps, and the display control unit control said plurality of LED lamps on and off at a certain position of a certain area in one circle of rotation.

In another aspect of the present invention, preferably, the character display system is remotely piloted vehicle including remotely piloted vehicle body, propeller and remote control; the rotary component is said remotely piloted vehicle body; the power supply, the display control unit and the character receiving unit configured within said remotely piloted vehicle body; the plurality of LED lamps are vertically configured on one side of said remotely piloted vehicle body; the character emitting unit is configured within the remote control; the character editing unit includes a display screen and button configured on remote control.

In a further aspect of the present invention, preferably, the character display system is electric fan including fan body, blades; the rotary component is blades; power supply, the display control unit the character emitting unit and the character receiving unit are configured within the fan body; the plurality of LED lamps are configured on the blades; the character editing unit includes display screen and button configured on the panel of fan body.

In another aspect of the present invention, preferably, the LED lamps are five to ten.

In another aspect of the present invention, preferably, the character set is ASCII character set.

In another aspect of the present invention, preferably, the string length is one to twenty.

In another aspect of the present invention, preferably, the rotational speed of the rotary component is greater than 20 revolutions per second.

In another aspect of the present invention, preferably, at array arrangement of the plurality of LED lamps is a linear arrangement.

In another aspect of the present invention, the present invention provides a character display method using the character display system described above including the steps of

taking out characters or character string from the pre-stored character set in said character storage unit and editing characters or character string and outputting the signal of the ideographic characters or character string toward character receiving unit via character editing unit;

receiving signal of the ideographic character or character string edited by said character editing unit and transmitting the received signal of the ideographic character or character string toward character receiving unit via character emitting unit;

character receiving signal of the ideographic character or character String transmitted by the character emitting unit and transmitting signal of the ideographic character Or character String toward the display Control unit via character receiving unit;

receiving the signal of the ideographic character or character string transmitted by the character receiving unit and controlling the plurality of LED lamps on and off at a certain position of a certain area in one circle of rotation based on the received signal via display control unit.

In another aspect of the present invention, the LED lamps are five.

The present invention produces the advantageous effect as follows; the system of the present invention allows users to self-define display content of the LED lamp configured on rotary component by character editing unit, increasing interactivity and playability of the rotary product.

A variety of display content can be modified randomly, and each of multiple products displays different content according to the system of the present invention.

One revolution time of a plurality of LED lamps is less than the time of human visual after-image and persistence of visual, letter style has been suspending in its rotary cylindrical surface, the text can be very clearly shown and also has a very strong stability according to the method of the present invention.

Still further objects and advantages will become apparent from the description of the preferred embodiment of the present invention below and the accompanying drawings.

### BRIEF DESCRIPTION OF THE DRAWINGS

FIG. 1: block diagram of a character display system of the present invention;

FIG. 2: configuration schematic diagram of the LED lamps according to the present invention, giving the display principle of characters;

FIG. 3: stereo schematic view of a remotely piloted vehicle;

FIG. 4: elevation view of the remotely piloted vehicle of FIG. 3;

FIG. 5: back view of the remotely piloted vehicle of FIG. 3;

FIG. 6: stereo schematic view of a remote control;

FIG. 7: stereo schematic view of a electric fan.

The drawing symbols arc described as follows:

1: Rotary component; 2: Power supply; 3: LED lamps; 4: Display control unit; 5: Character storage unit; 6: Character editing unit; 7: Character emitting unit; 8: Character receiving unit; 9: Power supply; 11: Section; 12,131,132,141,142,151,152,161,162; Bright spot position; 20: Remotely piloted vehicle; 21: Remotely piloted vehicle body; 22: Propeller; 23: LED lamps; 24: Signal reception head; 25: Power switch; 30; Remote control; 31: Button; 32: Display screen; 33: Infrared emission head; 40: Electrical fan; 41: Fan body; 42: Blades; 43: LED lamps; 44: Button: 45: Display screen.

### DETAILED DESCRIPTION OF THE PREFERRED EMBODIMENT

The present invention will be further described, with reference to the specific examples below.

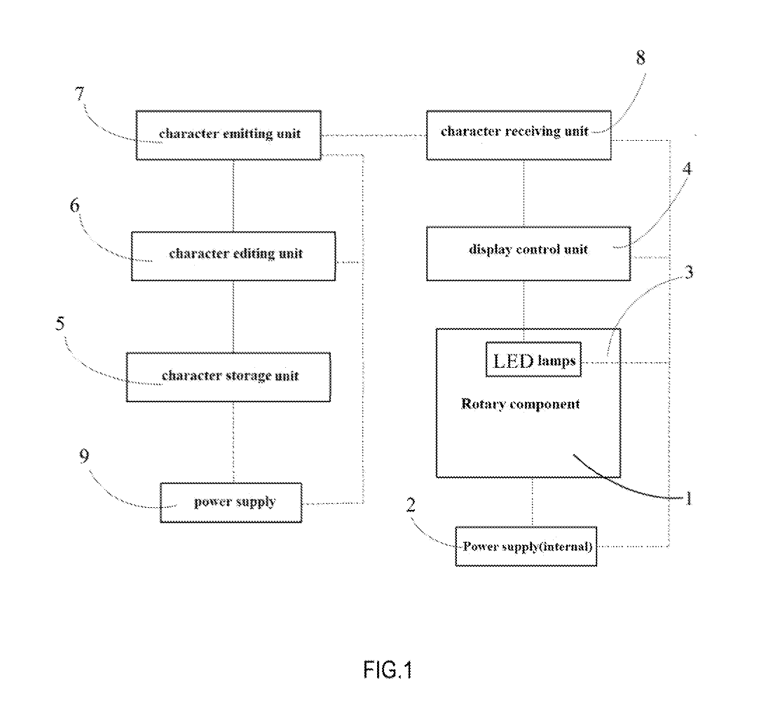

As shown in FIG. 1, a character display system according to the present invention, including: rotary component 1; power supply 2 electrically connected to said rotary component (1) a plurality of LED lamps 3 configured on said rotary component (1) in an array arrangement and connected to said power supply 2; display control unit (4) electrically connected with said power supply 2 and communicatively connected with said plurality of LED lamps 3; character storage unit 5 pre-storing character set therein and providing storage space liar storing character thereof, and electrically connected with said power supply 9 and communicatively connected with character editing unit 6; character editing unit 6 electrically connected to the power supply 9 and communicatively connected with said character storage unit 5 in order to take out of characters from said character storage unit 5 and to edit characters or character string, and output the signal of the ideographic characters or character string; character emitting unit 7 electrically connected to power supply 9 and communicatively connected with said character editing unit 6 so as to emit signal of the ideographic characters or character string edited by said character editing unit 6; and,

Character receiving unit $ electrically connected to said power supply 2 and communicatively connected with said character emitting unit 7 so as to receive the signal of the ideographic character or character string and transmits the signal of the ideographic characters or character string toward said display control unit 4;

Wherein, said display control unit 4 provides a communication connection so as to transmit the signal of ideographic characters or character string of said character receiving unit 8 to the LED lamps 3, and the display control unit. 4 control said plurality of LED lamps 3 on and off at a certain position of a certain area in one circle of rotation.

In the character display system according to present invention, preferably, character set stored in character storage unit 5 is a standard ASCII character set.

In the character display system according to present invention, preferably, the plurality of LED lamps 3 are linearly arranged on the rotary component 1.

In the character display system according to present invention, rotary component 1 can be connected with the power supply 2, display control unit 4, character receiving unit 8 as a whole body or a separate part when separating in parts, the connection of the plurality of LED lamps 3 with display control unit 4 is carried out via electric brush way (not shown).

In the character display system according to the present invention, the display control unit 4 comprises a chip (not shown), the character set is loaded and display program of each character of the character set is preset within the chip.

In the character display system according to the present invention, character emitting unit 7 is connected with character receiving unit 8 via a wire communication connection or wireless communication connection; when via wire communication connection, display control unit 4, character receiving unit 8, character emitting unit 7, character editing unit 6 are configured on the same circuit board (not shown); when via wireless communication connection, character emitting unit 7 is configured on a remote control (not shown) used for operating, rotary device, the character editing unit 6 is also configured on the remote control.

When the character display system of the present invention is working, rotation of the LED lamps 3 is driven by rotary component 1, control unit 4 control each of LED lamps 3 on and off when rotating in a certain area of one circle rotation, producing display effect therefrom to achieve visual stagnation of the human eyes, people can see the characters displayed in the rotation space, said control might be carried out by the display control program in display control unit 4. Character emitting unit 7 emits the signal of characters or character string generated in character editing unit 6 to character receiving unit 8, the characters or character string received by character receiving unit 8 is displayed via the plurality of LED lamps 3. Modification of display characters can be done when rotary component 1 is rotating so as to produce a dynamic effect.

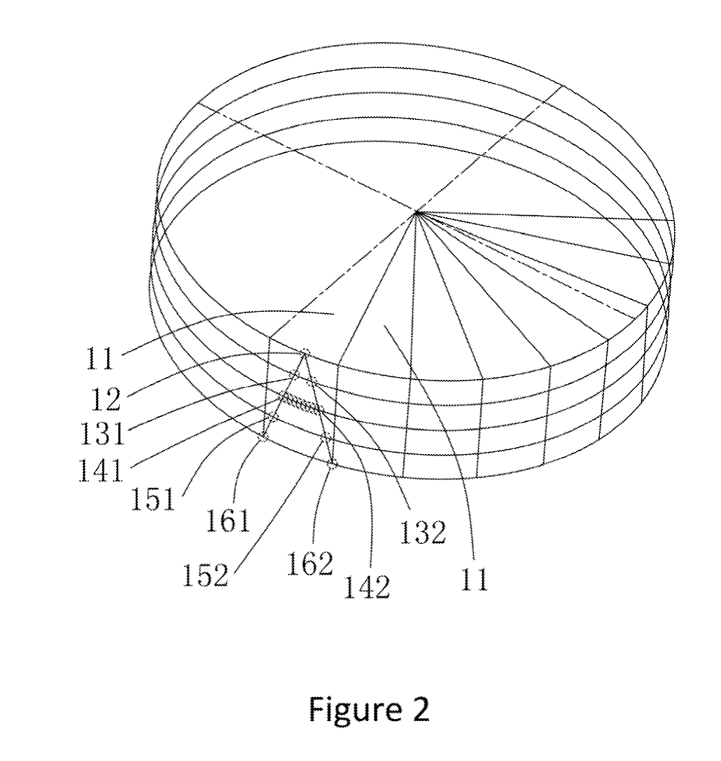

Referring to FIG. 2, an example of working principle of the present invention for displaying eight characters of the character string by five LED lamps is described. A plurality of LED lamps on as rotary component (not numbered) rotates along with the rotary component to form a cylindrical surface. An arc in one circumference is divided into eight of equivalent section 11. Displaying the letter “A” in the first section 11 as an example, when the LED lamps rotated within the first section 11, the first LED lamp is located at the bright spot position 12 of the first section 11, the first LED lamp lights on for a second and then off; when the second LED lamp is located at its first bright spot position 131 of first section 11, the second LED lamp lights on for a second and then off; when the third LED lamp is located at its first bright spot position 141 of the first section 11, the third LED lamp has been lighting on until it is located at the bright spot position 142 and then off; when the forth LED lamp is located at its first bright spot position 151 of first section 11, the forth LED lamp lights on for a second and then off; when the fifth LED lamp is located at its first bright spat position 161 of first section 11, the fifth LED lamp lights on for a second and then off when at its second bright spot position 162 of first section 11, the fifth LED lamp lights on for a second and then off again. So we can see a letter “A” formed by LED light point during, the rotational time of the first section 11. When rotational time of one revolution of five LED lamps is less than the time of the human visual afterimage, we will feel likely seeing letter “A” suspending on a rotating cylindrical surface. The display principle for displaying the second character to the eighth character is the same as that for displaying the first letter, such that the display of the character strings composed of eight characters are completed. Because display control unit 4 preset display program of all the characters in characters set, after character receiving unit receives self-defined character string, the display control unit 4 adjusts the display program to display different strings.

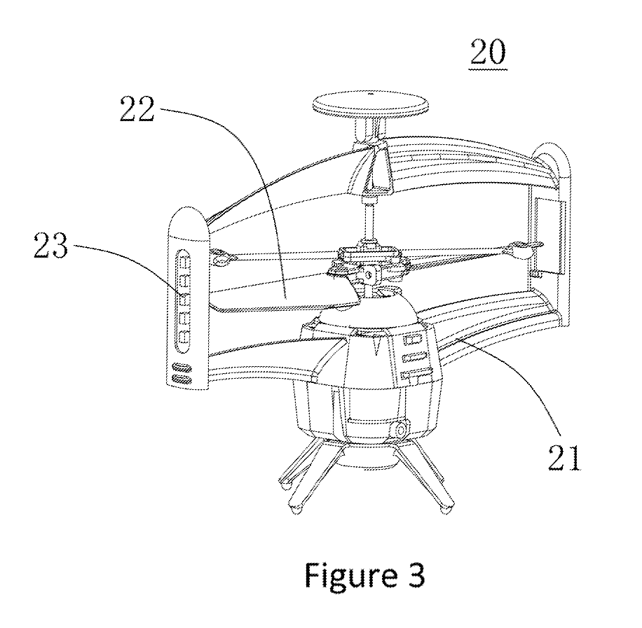

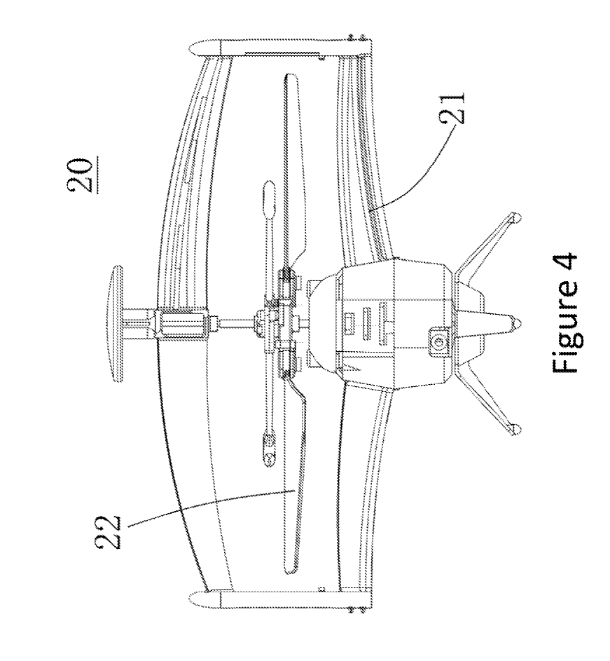

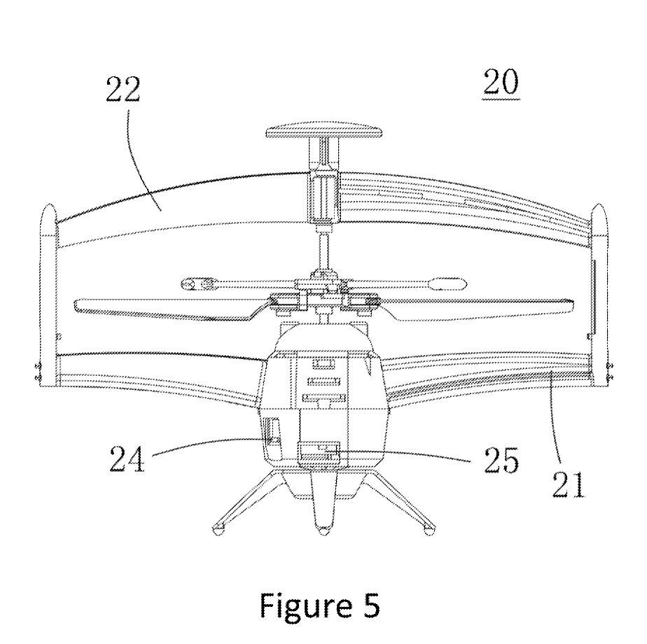

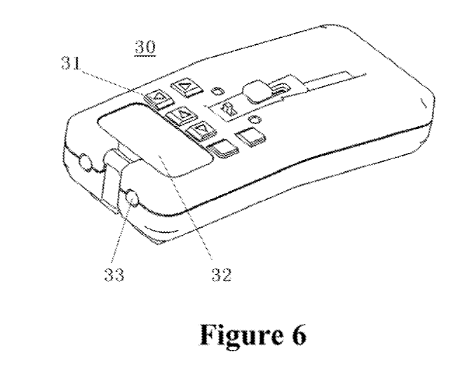

Referring to FIGS. 3-6, the present invention is actually applied to a remotely piloted vehicle 20, the type of said remotely piloted vehicle 20 may be different each other. An example of said remotely piloted vehicle 20 as shown in FIG. 3 and FIG. 6 includes remotely piloted vehicle body 21, propeller 22 and remote control 30. Said remotely piloted vehicle body 21 is a rotary component 1 the circuit board of power supply 2, display control unit 4, character receiving unit 8 or the same in FIG. 1 are configured within said body 21 of said remotely piloted vehicle 20. A plurality of LED lamps 23 (corresponding to LED lamps 3 of FIG. 1) are configured on a side of said body 21. A plurality of LED lamps 23 are configured vertically and parallelly with the rotary shaft. The rotation of said propeller 22 of the remotely piloted vehicle 20 is controlled by remote control 30. When rotating, the lifting force generated by the rotation of said propeller 22 enforce said remotely piloted vehicle 20 to suspend in air and drive said body 21 to rotate with opposite direction of rotation direction of said propeller 22. Character emitting unit 7 and character editing unit 6 of FIG. 1 are configured within said remote control 30, characters are edited by button 31 and display 32 of the remote control. The edited character string is emitted to character receiving unit 8 of said remotely piloted vehicle 20 via infrared emission head 33. The remotely piloted vehicle 20 receives infrared signal via signal receiver head 24 below said body 21. Display control unit 4 controls the received signal by receiving unit 8 to display via a plurality of LED lamps 23. The number of the LED lamp 23 is optionally selected from live to ten. The length of character string is appropriately 1-20. The rotational speed of said body 21 has to achieve visual stagnation of the human eyes, the speed has to exceed 20 revolutions per second, or has to achieve this speed in a period of time. In different shapes of a remotely piloted vehicle, the present invention can be carried out if there is a rotary component and its speed can produce the effect of the human visual stagnation, and the LED lamps on said rotary component is in parallel or angled with its rotational axis.

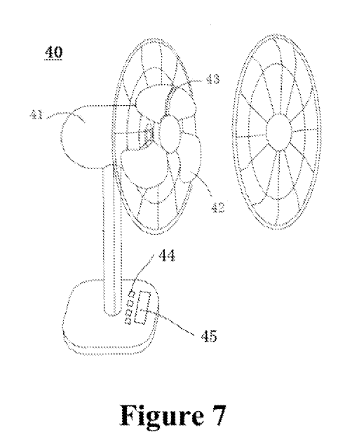

Referring to FIG. 7, the present invention can also be applied, to electric fan 40. The electric fan 40 comprises fan body 41, blades 43, said blades 42 is used as a rotary component, power supply 2, display control unit 4, character emitting unit 7 and character receiving unit 8 of FIG. 1 are configured within said fan body 41 of FIG. 1 character emitting unit 7 of FIG. 1 is connected with character receiving unit 8 via wire connection, a plurality of LED lamps 43 are configured on said blades 42. Character editing unit 6 of FIG. 1 in the present embodiment comprises button 44 and display screen 45 configured on the fin body panel, file plurality of LED lamps can be connected with said fan body 41 via electric brush manner.

The present invention can also he applied to various rotating toys, accessories, and mechatronics product, such as toy cars, and even cars, airplane; it can also produce unexpected effects in those products.

The preferred embodiment of the present invention has been specifically described above, but the present invention is not limited to said embodiments, may be made of various equivalent variant or replacement without departing from the innovative spirit of the present invention by the skilled person in the prior art, these equivalent modification or replacement are included within the scope as claimed in the claims of the present application.

One skilled in the art will understand that the embodiment of the present invention as shown in the drawings and described above is exemplary only and not intended to be limiting. The embodiments described above are for the purposes of illustrating the functional and structural principles of the present invention and is subject to change without departing from such principles. Therefore, this invention includes all modifications encompassed within the spirit and scope of the following claims.

What is claimed is:

1. A system for displaying characters, including:
rotary component (1);
power supply (2,9);
said power supply (2) is connected to said rotary component (1);
a plurality of LED lamps (3) configured on said rotary component (1) in an army arrangement and electrically connected to said power supply (2);
display control unit (4) electrically connected with said power supply (2) and communicatively connected with said plurality of LED lamps (3), wherein said character display system further including:
character storage unit (5) pre-storing character set therein and providing storage space for storing character thereof, and electrically connected with said power supply (9) and communicatively connected with character editing unit (6);
character editing unit (6) electrically connected to the power supply (9) and communicatively connected with said character storage unit (5) in order to take out of characters from said character storage unit (5) and to edit characters or character string, and output the signal of the ideographic characters or character string;
character emitting unit (7) electrically connected to power supply (9) and communicatively connected with said character editing unit (6) so as to emit signal of the ideographic characters or character string edited by said character editing unit (6); and,
character receiving unit (8) electrically connected to said power supply (2) and communicatively connected with said character emitting unit (7) so as to receive the signal of the ideographic character or character string and transmits the signal of the ideographic characters or character string toward said display control unit (4);
said display control unit (4) provides a communication connection so as to transmit the signal of ideographic characters or character string of said character receiving unit (8) to the LED lamps (3), and the display control unit (4) control said plurality of LED lamps (3) on and off at a certain position of a certain area in one circle of rotation.

2. The system for displaying characters, according to claim 1, wherein said system is remotely piloted vehicle including, remotely piloted vehicle body (21), propeller (22) and remote control (30);
the rotary component (1) is said remotely piloted vehicle body (21); the power supply (2), said display control unit (4) and the character receiving unit (8) are configured within said remotely piloted, vehicle body (21);
the plurality of LED lamps (3) are vertically configured on one side of said remotely piloted vehicle body (21);
the character emitting unit (7) is configured within said remote control (30);
the character editing unit (6) includes display screen (31) and button (32) configured on said remote control (30).

3. The system for displaying characters according to claim 1, wherein said system is electrical fan (40), said electrical fan includes fan body (41), blades (42);
the rotary component (1) is said blades (42);
the power supply (2), the display control unit (4), the character emitting unit (7) and the character receiving unit (8) are configured within said fan body (41);
the plurality of LED lamps (3) are configured on said blades (42);
the character editing unit (6) includes screen (45) and button (44) configured on a panel of said fan body (41).

4. The system for displaying characters according to claim 1, wherein the LED lamps are five to ten.

5. The system for displaying characters according to claim 2, wherein the LED lamps are five to ten.

6. The system for displaying characters according to claim 3, wherein the LED lamps are five to ten.

7. The system for displaying characters according to claim 1, wherein the character set is a ASCII character set.

8. The system for displaying characters according to claim 2, wherein the character set is a ASCII character set.

9. The system for displaying characters according to claim 3, wherein the character set is a ASCII character set.

10. The system for displaying characters according to claim 1, wherein the string length is one to twenty.

11. The system for displaying characters according to claim 2, wherein the striae length is one to twenty.

12. The system for displaying characters according to claim 3, wherein the string length is one to twenty.

13. The system for displaying characters according to claim 1, wherein rotational speed of the rotary component (1) is greater than 20 revolutions per second.

14. The system for displaying characters according to claim 2, wherein rotational speed of the rotary component (1) is greater than 20 revolutions per second.

15. The system for displaying characters according to claim 3, wherein rotational speed of the rotary component (1) is greater than 20 revolutions per second.

16. The system for displaying characters according to claim 1, wherein the array arrangement of a plurality of LED lamps (3) is a linear arrangement.

17. The system for displaying characters according to claim 2, wherein the array arrangement of a plurality of LED lamps (3) is a linear arrangement.

18. The system for displaying characters according to claim 3, wherein the array arrangement of a plurality of LED lamps (3) is a linear arrangement.

19. A method for displaying characters according, to claim 1, comprising the steps of:
taking out characters or character string from the pre-stored character set in said character storage unit (5) and editing characters or character string and outputting the signal of the ideographic characters or character string toward character receiving unit (7) via character editing unit (6);
receiving signal of the ideographic character or character string edited by said character editing unit (6) and transmitting the received signal of the ideographic character or character string toward character receiving unit (8) via character emitting unit (7);
character receiving signal of the ideographic character or character siring transmitted by the character emitting unit (7) and transmitting signal of the ideographic character or character string toward the display control unit (4) via character receiving unit (8);
receiving the signal of the ideographic character or character string transmitted by the character receiving unit (8) and controlling the plurality of LED lamps (3) on and off at a certain position of a certain area in one circle of rotation based on the received signal via display control unit (4).

20. The method for displaying characters according to claim 19, wherein said LED lamps are five.
